(19) United States
(12) Patent Application Publication
(10) Pub. No.: US 2007/0206602 A1
(43) Pub. Date: Sep. 6, 2007

(54) METHODS, SYSTEMS AND APPARATUS FOR MANAGING DIFFERENTIATED SERVICE CLASSES

(75) Inventors: MITRI HALABI, San Jose, CA (US); Sanjay Khanna, Fremont, CA (US); Robert J. Colvin, San Jose, CA (US); Rishi Mehta, San Jose, CA (US)

Correspondence Address: FITZPATRICK CELLA HARPER & SCINTO, 30 ROCKEFELLER PLAZA, NEW YORK, NY, 10112, US

(73) Assignee: Tellabs San Jose, Inc., Naperville, IL (US)

(21) Appl. No.: 11/463,230

(22) Filed: Aug. 8, 2006

Related U.S. Application Data
(60) Provisional application No. 60/778,308, filed on Mar. 1, 2006.

(51) Int. Cl. H04L 12/56

(52) U.S. Cl. 370/395.4

(57) ABSTRACT

Differentiated service classes on a label switch path are managed by comparing at least one packet field value included in a packet of data to mapping field values of a mapping that correlates the mapping field values with queues. The packet is stored into one of the queues based on the comparing. A first subset of the queues is scheduled using a first queue scheduling algorithm and a second subset of the queues is scheduled using a second queue scheduling algorithm. The packet is transmitted onto the label switch path in accordance with a predefined scheduling order of the first subset of the queues and the second subset of the queues.

### CROSS REFERENCE TO RELATED APPLICATIONS

This application claim priority to, and the benefit of, U.S. Provisional Patent Application Ser. No. 60/778,308, filed Mar. 1, 2006, which is hereby incorporated by reference in its entirety.

### BACKGROUND OF THE INVENTION

1. Field of the Invention

The present invention generally relates to optical communication networks, and more particularly to a method, system, computer program product, and apparatus for managing differentiated service classes.

2. Related Art

Communications networks, such as optical communications networks, may use routers provisioned to carry network communications according to service plans between a service provider and a customer. For example, a customer may have a high cost service plan with the service provider that ensures their network communications are transmitted through the network at a guaranteed rate. Lower cost service plans may allow the service provider to carry the communications at a less than optimal rate depending upon congestion of the network.

FIG. 1 is a network diagram of an exemplary optical network 100 that includes four nodes: router A 105a, router B 105b, router C 105c, and router D 105d (collectively, routers 105a . . . d). Coupled between the routers 105a . . . d are fiber optic links 110a, 110b, 110c, 110d (collectively, fiber optic links 110a . . . d). As illustrated in FIG. 1, three fiber optic links 110a, 110c, and 110d are configured to support an OC-192 fiber optic network link, and the fourth fiber optic link 110b is configured to support an OC-48 fiber optic network link. An OC-192 fiber optic link can support a data rate of 10 Gbps and an OC-48 fiber optic link can support a data rate of 2.488 Gbps. Other fiber optic link data rates, such as 40 Gbps (e.g., OC-768), may also be supported on the fiber optic links 110a . . . d.

Any of the fiber optic links 110a . . . d may be configured as a communications “trunk” to handle many signals simultaneously, and to connect nodes in a communications system which can carry communications data at optical rates (e.g., OC-192, OC-48). The type of traffic communicated can be voice (as in the conventional telephone system) data, computer programs, images, video signals, control signals, and the like.

Fiber optic link configuration can be performed using a framework that provides for the designation, routing, forwarding, and switching of traffic flows through the network, called Multi-Protocol Label Switching (MPLS). In MPLS networking, a Label Switched Path (LSP) is set up as a path through an MPLS network. The path begins at a Label Edge Router (LER) which prepends an outer label (also sometimes referred to as “outer header” or simply “header”) to a packet used to forward the packet to the next hop. The packet is then forwarded by the LER to the next router in the path. Along the packet's route, the packet's outer label is swapped for another outer label by intermediary network nodes, such as label switching routers (LSRs), which in turn forward the packet to the next router. The last router in the path removes the outer label from the packet and forwards the packet based on the header of its next layer. Due to the forwarding of packets through an LSP being opaque to higher network layers, an LSP is also sometimes referred to as an MPLS tunnel.

An exemplary LSP 115 is illustrated in FIG. 1 as being configured between router A 105a and router C 105c by traversing fiber links 110d and 110c via router D 105d. There can be many LSPs on a single fiber link, although for convenience only one LSP is represented in FIG. 1.

Generally, network traffic is sorted into service classes by application and service type. Traffic for a given service class is then scheduled (or mapped) onto LSPs according to a bandwidth configured for each service type. Each of these prior art LSPs can thus be referred to as a “bandwidth configured” LSP. For example, the LSP 115 may be configured to support 10 Mbps, where configuring or provisioning (used herein synonymously) the LSP 115 may be done by signaling to the routers along the route, router A 105a, router D 105d, and router C 105c, to allow the LSP 115 to support communications up to the specified rate.

Typically certain types of traffic are more time-constrained than others. Network service providers can account for this by configuring its networks to supply better service to selected network traffic based on factors such as dedicated bandwidth, delay, loss characteristics, controlled jitter and latency. Before doing so, it is necessary to determine the quality necessary for acceptable communications on a per service basis so that the traffic can be scheduled. If an application or service wishes to use the network to transport a particular kind of traffic (e.g., voice, video, data, etc.), it must first inform the network about what kind of traffic is to be transported, and the performance requirements of that traffic. For example, voice traffic requires scheduling that provides low delay, real-time traffic transport. At the opposite spectrum, another type of traffic, signaling and operation and maintenance (OAM) traffic may is scheduled on a tunnel configured as a non-real-time service transport tunnel having less bandwidth.

Each type of service category has a predefined method of relating traffic characteristics and requirements to network behavior. The Constant Bit Rate (CBR) service category, for example, is used for connections that transport traffic at a consistent bit rate, where there is an inherent reliance on time synchronization between the traffic source and destination. CBR is tailored for any type of data for which the end-systems require predictable response time and a static amount of bandwidth continuously available for the life-time of the connection. Another type of service category, the real time variable bit rate (VBR-rt or rt-VBR) service category, is used for connections that transport traffic at variable rates. VBR-rt traffic thus relies on accurate timing between the traffic source and destination. Sources that use VBR-rt connections are expected to transmit at a rate that varies with time (for example, traffic that can be considered bursty).

The non-real time variable bit rate (VBR-nrt or nrt-VBR) service category is used for connections that transport variable bit rate traffic for which there is no inherent reliance on time synchronization between the traffic source and destination. However, traffic communicated using VBR-nrt requires an attempt at a guaranteed bandwidth or latency.

The Expedited Forwarding (EF) service category is used for applications that require a hard guarantee on the delay and jitter. Typically mission critical applications would require this type of service.

The Assured Forwarding (AF) service category is used to offer different levels of forwarding assurances to IP packets received from a customer service. Unlike the EF service category, the AF service category does not guarantee low latency and low jitter to IP packets. The unspecified bit rate (UBR) service category is similar to VBR-nrt, because it is used for connections that transport variable bit rate traffic for which there is no reliance on time synchronization between the traffic source and destination.

Network devices, such as routers and switches, use buffers during periods of congestion to queue packets for subsequent processing. After being processed by the network device, the packets are then sent to their destination based on priority. This assignment is carried out by software known as a scheduler. Schedulers queue traffic based on queuing algorithms.

Strict priority queuing assigns a priority (e.g., high, normal, low) to traffic. High priority traffic gets absolute preferential treatment over lower priority traffic, to the extreme that low priority traffic may get no bandwidth whatsoever during peak utilization periods. Weighted queuing, such as weighted fair queuing (WFQ), is a method which schedules low-volume traffic first, while letting high-volume traffic share the remaining bandwidth. This is handled by assigning a weight to each flow, where lower weights are the first to be serviced. Another type of scheduling technique is commonly referred to as “best effort” scheduling. Services that use best effort scheduling algorithms do not take into account any requested or realized quality of service (QoS) properties of packet flows. An example of such a technique is a first-in, first-out (FIFO) scheduling technique, which processes packets as they arrive.

Call admission control (CAC) protocols play a significant role in providing a desired QoS. A CAC protocol may be employed, for example, in each of the routers 105a . . . d to prevent the LSPs 115 associated with a given network node from exceeding a specified rate, such as a burst rate of 10 Mbps (for one LSP) or a line rate of 10 Gbps (across all LSPs). In operation, this means that when the LSP 115 is being signaled (e.g., configured through each of the routers 105a, 105d, 105c along its network path 110d and 110c), the CAC protocol determines whether the LSP 115 is allowed to be built based on parameters provisioned in each of the routers. For example, if the LSP 115 is requesting a burst rate of 50 Mbps but the allowed maximum burst rate is set at 10 Mbps, the CAC protocol denies provisioning of the LSP 115. In such a case, the LSP 115 may have to be provisioned on a different optical path, such as an optical path along an optical fiber that has been provisioned to support 50 Mbps via the same network nodes or along different network nodes, such as from routers A to C through router B 105b. The CAC protocol may also (i) sum (a) rates of all currently provisioned LSPs and (b) a rate of a requested LSP and (ii) deny provisioning if the total rate exceeds the rate supported by the trunk. Once an LSP is provisioned, a shaper (not shown) within each of the routers prevents the LSP 115 from exceeding the provisioned data rate.

One way to implement a network is to employ a technique called “pseudo wire emulation edge-to-edge” (PWE3). Generally, PWE3 is a technique that emulates the essential attributes of a service over a packet-switched network acting as a transport network. PWE3 utilizes pseudo wires (PWs), which are mechanisms that emulate the essential attributes of a particular service. In a network configuration such as the one described above, a QoS model is used to implement services which use weighted classes and multiple groupings, such as multipoint Layer 2/Layer3 (L2/L3) services.

There is a need for an improved way of carrying multiple services (with different requirements) over a single path in the network.

There is also a need to provide a mechanism to create an LSP which can combine both real-time and non-real-time services with differentiated levels among those services.

Given the foregoing, what is needed is a system, method and computer program product for methods, and an apparatus, for managing differentiated service classes.

### BRIEF DESCRIPTION OF THE INVENTION

The present invention meets the above-identified needs by providing a system, method, apparatus and computer program product for managing differentiated service classes.

An advantage of the present invention is that it can carry multiple services with different requirements over a single path in the network.

Another advantage of the present invention is that it provides a mechanism to create an LSP which can combine both real-time and non-real-time services with differentiated levels among those services.

In accordance with one embodiment of the present invention, there is provided a method, apparatus, system and computer program product for managing differentiated service classes on a label switch path by comparing at least one packet field value included in a packet of data to mapping field values of a mapping that correlates the mapping field values with queues. The packet is stored into one of the queues based on the comparing. A first subset of the queues is scheduled using a first queue scheduling algorithm and a second subset of the queues is scheduled using a second queue scheduling algorithm. The packet is transmitted onto the label switch path in accordance with a predefined scheduling order of the first subset of the queues and the second subset of the queues.

In accordance with another embodiment of the present invention a system for managing a plurality of differentiated service classes on a label switch path on a network is provided including a first node device operable to prepend a label onto a packet of data, the label including a packet field value defining a priority of the packet, and to transmit the packet with the label onto the network and a second node device operable to receive the packet from the network, to compare the at least one packet field value with a predefined mapping defined to correlate one or more mapping field values with a plurality of queues, store the packet into one of the queues based on a comparison of the packet field value and the mapping field values, to schedule a first subset of the queues using a first queue scheduling algorithm, to schedule a second subset of the queues using a second queue scheduling algorithm, and to transmit the packet to a next hop in accordance with a predefined scheduling order of the first subset of the queues and the second subset of the queues.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is a system diagram of an exemplary prior art optical network.

FIG. 2 is a system diagram of an exemplary optical network in which the present invention, in an embodiment, can be implemented.

FIG. 3 is an architecture diagram of an exemplary data processing system in accordance with an exemplary embodiment of the present invention.

FIG. 4 is a logical diagram of a circuit device in accordance with one embodiment of the present invention.

FIG. 5 illustrates exemplary service classes organized based on scheduling priorities in accordance with an embodiment of the present invention.

FIG. 6 illustrates exemplary scheduler for scheduling differentiated service classes in accordance with an embodiment of the present invention.

FIG. 7 illustrates an exemplary offering of different types of traffic associated with different services classes which are prioritized using both strict and weighted scheduling in accordance with an embodiment of the present invention.

FIG. 8 illustrates two different Label Switched Paths (LSPs) in accordance with an embodiment of the present invention.

FIG. 9 depicts an exemplary EXP bit mapping of a premium E-LSP configured to communicate all strict priority service classes, in accordance with an embodiment of the present invention.

FIG. 10 depicts an exemplary EXP bit mapping of an E-LSP configured to communicate all weighted classes, in accordance with an embodiment of the present invention.

FIG. 11 illustrates a Label Switched Path (LSP) having a mixture of strict and weighted classes in accordance with an embodiment of the present invention.

FIG. 12 depicts an exemplary EXP bit mapping of an E-LSP configured to communicate a mixture of strict and weighted classes, in accordance with an embodiment of the present invention.

FIG. 13 is a flowchart illustrating the general processing of packets according to one embodiment of the present invention.

FIG. 14 is a flowchart illustrating processing of service classes associated with strict priority scheduling according to one embodiment of the present invention.

FIG. 15 is a continuation of the flowchart depicted in FIG. 14 illustrating processing of service classes associated with weighted scheduling according to one embodiment of the present invention.

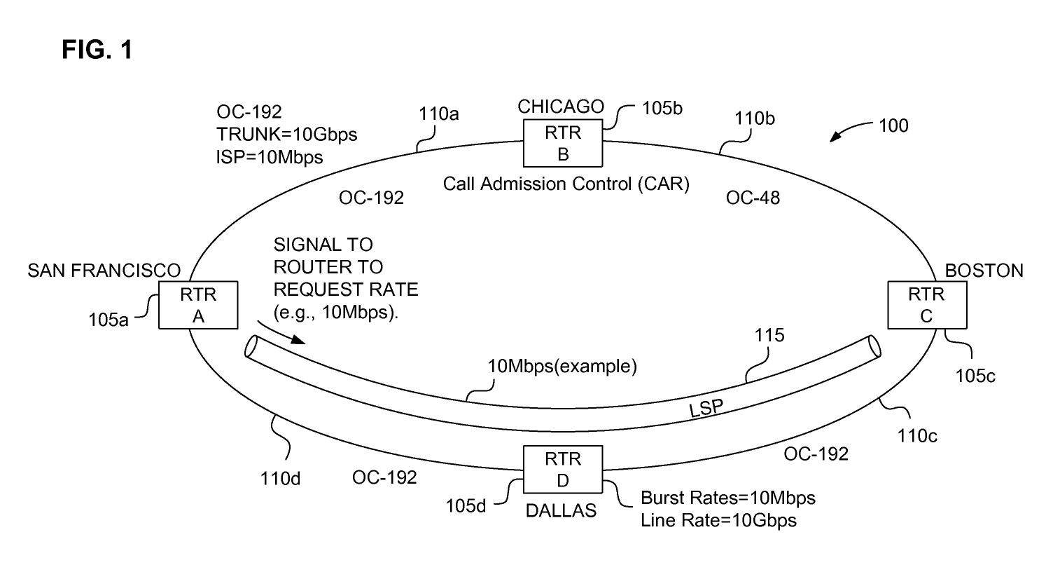

### DETAILED DESCRIPTION

The present invention is directed to methods, systems, an apparatus and computer program products for configuring an LSP which can offer both real-time and non-real-time services with differentiated levels among those services. The present invention is now described in more detail herein in terms of an exemplary multi-protocol label switching (MPLS) optical network environment. This is for convenience only and is not intended to limit the application of the present invention. In fact, after reading the following description, it will be apparent to one skilled in the relevant art(s) how to implement the following invention in alternative embodiments (e.g., non-optical networks, non-MPLS environments, and the like).

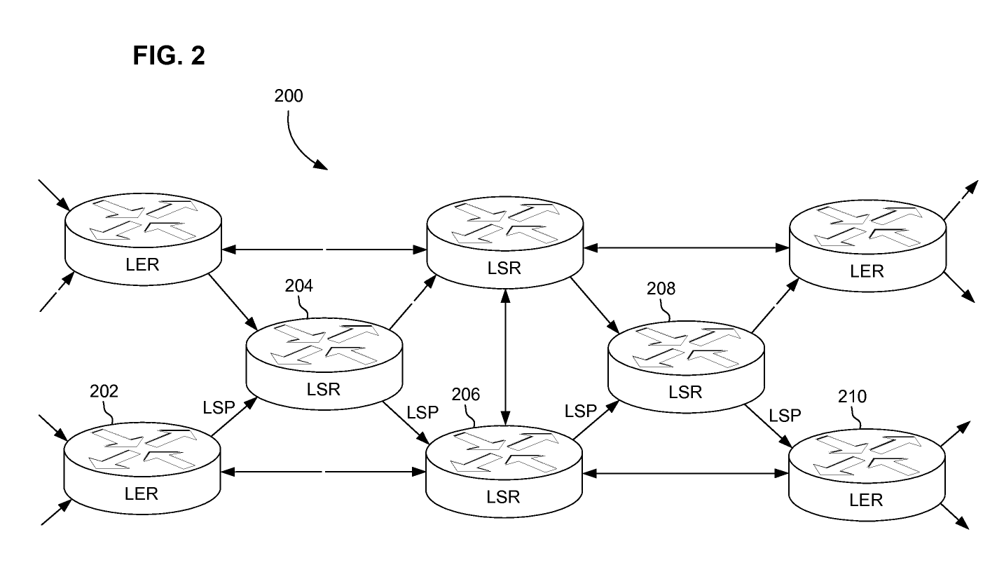

FIG. 2 depicts an exemplary MPLS network environment 200 in which the present invention can be implemented. Network 200 includes label edge routers (LERs), including LER 202 and LER 210, and label switching routers (LSRs), including LSRs 204, 206, and 208. Network traffic entering LER 202, for example, is assigned a label switched path (LSP), which defines a path (or partial path) for the traffic through the network. For example, in the illustrated embodiment, an LSP is shown as traversing LER 202 to LSR 204 to LSR 206 to LSR 208 to LER 210. For this LSP, LER 202 is an ingress (originating) node for traffic, while LSRs 204, 206, and 208 are transit nodes, and LER 210 is an egress (terminating) node. As will be described in more detail below, the LSP is defined in accordance with, among other things, the types of services it will carry. Preferred embodiments of the present invention, described below, are implemented in the provider's LERs and LSRs (generally referred to as “node devices”) to allow the customer's network traffic to traverse the LSP.

The LERs and LSRs depicted in FIG. 2 can be implemented as data processing systems, and the present invention can be implemented as computer-executable program instructions stored on a computer-readable medium of the data processing systems. In other embodiments, software modules or circuitry can be used to implement the present invention. For example, the present invention can be implemented on a general purpose computer or on an application specific integrated circuit (ASIC), programmable gate array (PGA), field programmable gate array (FPGA), and the like.

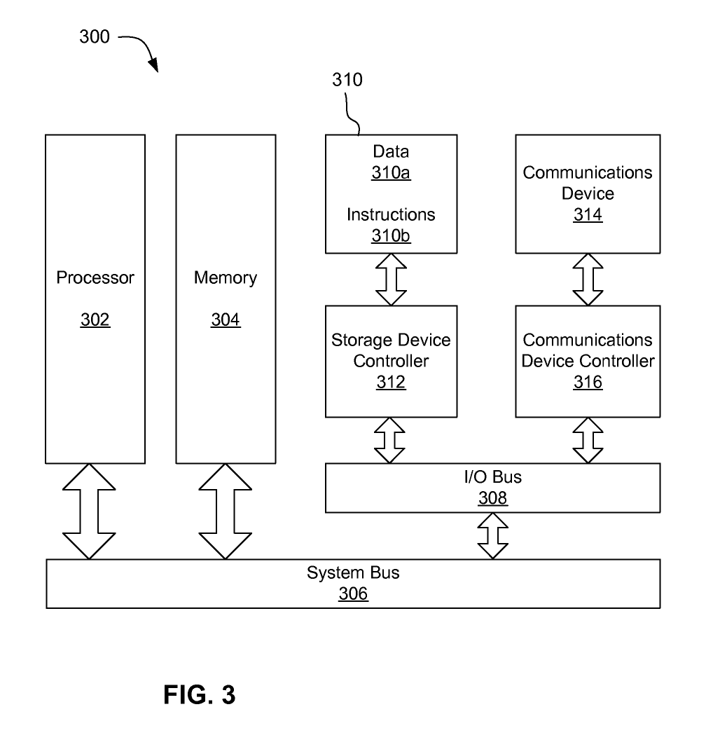

FIG. 3 is an architecture diagram for an exemplary data processing system 300, which could be used as an LER and/or LSR for performing operations as an originating, transit, or egress node in accordance with exemplary embodiments of the present invention described in detail below. Data processing system 300 includes a processor 302 coupled to a memory 304 via system bus 306. Processor 302 is also coupled to external Input/Output (I/O) devices (not shown) via the system bus 306 and an I/O bus 308. A storage device 310 having a computer-readable medium is coupled to the processor 302 via a storage device controller 312 and the I/O bus 308 and the system bus 306. The storage device 310 is used by the processor 302 and controller 312 to store and read/write data 310a and program instructions 310b used to implement the procedures described below. For example, those instructions 310b can perform any of the methods described below for operation as an originating node, a transit node, and/or a terminating node depending on the application of the system 300.

Processor 302 may be further coupled to a communications device 314 via a communications device controller 316 coupled to the I/O bus 308. Processor 302 uses the communications device 314 to communicate with a network (not shown in FIG. 3) transmitting multiple flows.

In operation, processor 302 loads the program instructions 310b from the storage device 310 into the memory 304. Processor 302 then executes the loaded program instructions 310b to offer differentiated services for network traffic that arrives at data processing system 300 and is queued in memory 304. Thus, processor 302 operates under the control of the instructions 310b to perform the methods of this invention. The present invention can also be implemented, for example, in a network router, switch or other node device.

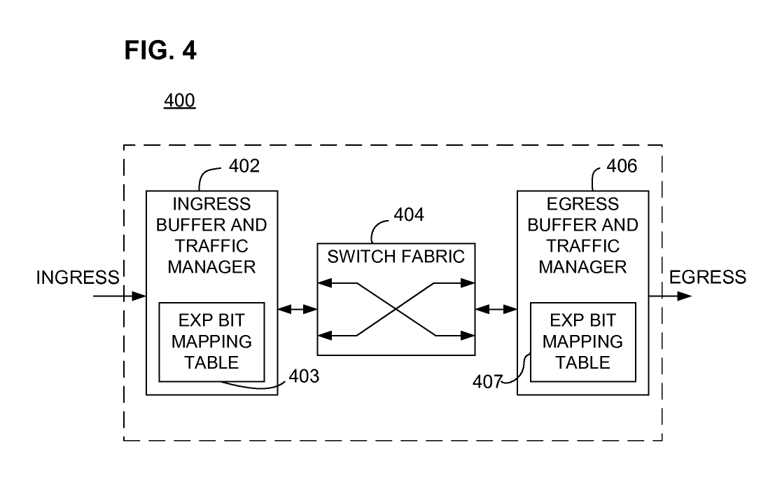

FIG. 4 illustrates a logical diagram 400 of the modules of an exemplary data processing system 300 (FIG. 3) or similarly organized circuit device (e.g., ASIC, PGA, FPGA, and the like) which could be used as an LER and/or LSR for performing operations as an originating, transit, or egress node in accordance with exemplary embodiments of the present invention. The modules may include hardware circuitry, software, and/or combinations thereof. In an exemplary embodiment, software routines for performing the modules depicted in logical diagram 400 can be stored as instructions 310b in memory 310 and executed by processor 302 of data processing system 300 (FIG. 3). Logical diagram 400 includes an ingress buffer and traffic manager 402 which includes a packet receiver (not shown) for receiving packets and is used to store the incoming packets in memory 304 and process them as will be described below in more detail with respect to FIGS. 13, 14 and 15. The header of an incoming packet contains information necessary for the circuit device 400 to appropriately prioritize the packet, including its type of traffic or “class of service” (CoS) (e.g., voice, video, file transfers, transaction processing, multicast, and the like), and drop precedence (e.g., low or high).

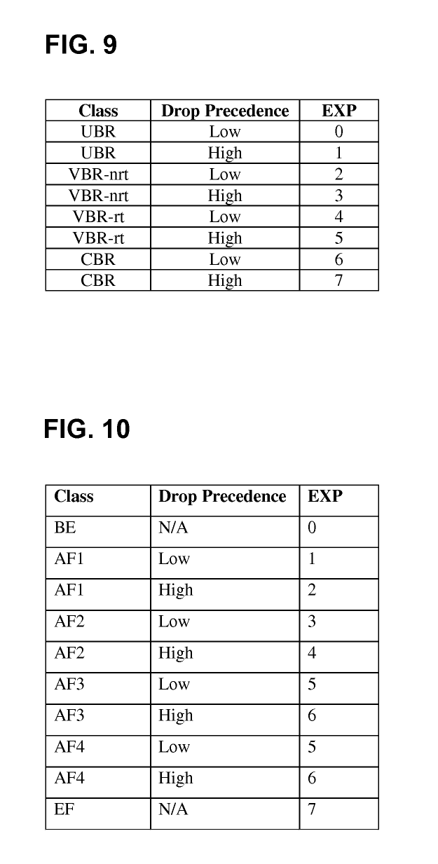

If the packet already is appended with an LSP label the packet is prioritized based on its EXP field value. If the node is an ingress node, then the Label Edge Router (LER) prepends an outer label to a packet containing the EXP field based on the type of traffic the packet is communicating. In particular, scheduling (or prepending a label to a packet) is based on a mapping stored in the EXP bit mapping register 403. A network operator through standard network configuration tools preconfigures the mapping, exemplary embodiments of which are shown in FIGS. 9, 10 and 12. The ingress buffer and traffic manager (also referred to as “ingress manager”) 402 is interfaced to a switch fabric 404 on the data path, which in turn, interfaces with an egress buffer and traffic manager (also referred to as an “egress manager”) 406. The egress manager's data flow is similar to that of the ingress manager's data flow. Particularly, the egress manager 406 includes a packet transmitter (not shown) and manages transmission of traffic stored in memory (e.g., queues organized in memory 304 (FIG. 3); not shown in FIG. 4) to the switch fabric 404 or out of an egress port, and updates registers, tables, and counters, and the like associated with network transmission. In addition, egress buffer and traffic manager 406 prioritize egress traffic in accordance with an EXP bit mapping stored in an egress bit mapping register 407 according to preconfigured policies based on, for example, class of service and/or drop precedence. Those skilled in the art will recognized that drop precedence is not applicable for certain types of service classes.

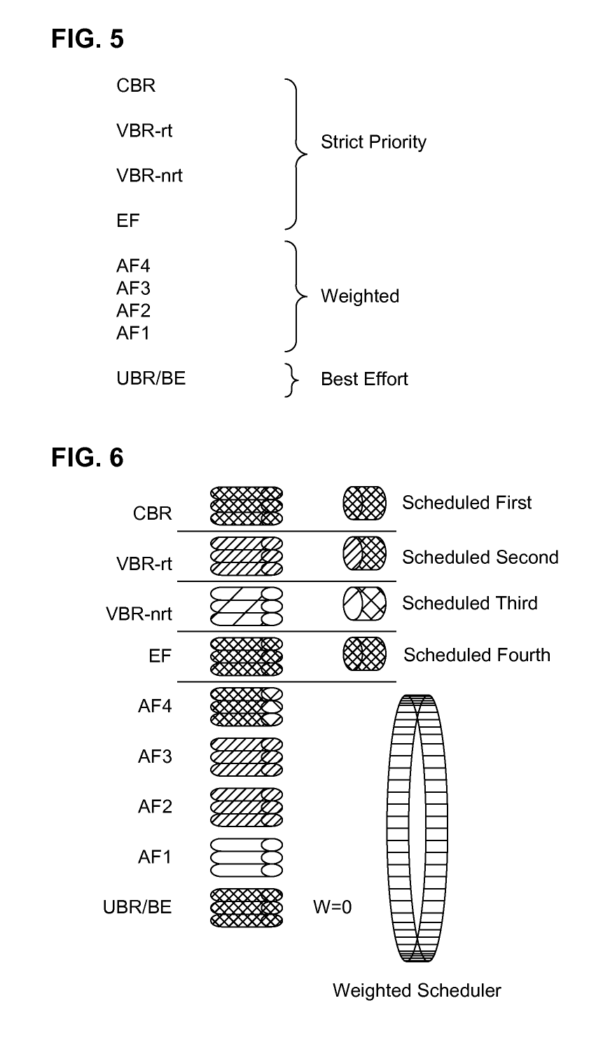

FIG. 5 illustrates exemplary service classes organized based on scheduling priorities and FIG. 6 represents a scheduler for scheduling service classes in accordance with exemplary embodiments of the present invention. The service classes are decoupled from the traffic parameters and policing and shaping aspects of a service class. The strict priority classes (e.g., CBR, VBR-rt, VBR-nrt, and EF) are scheduled based on priority. In other words, a lower priority service class is only scheduled when a higher priority service class has nothing to send. The weighted service classes (e.g., AF4, AF3, AF2 and AF1) have weights assigned to each service class. Consequently, each weighted service class is scheduled based on weights, and a service class with a higher weight is scheduled more frequently than a lower weight service class. Conversely, a service class with a lower weight is scheduled even if a higher weight service class has data to send. Also included in the service classes is a best effort service class BE and unspecified bit rate (UBR) service class. Other embodiments can use more than the service classes mentioned herein and other associations to strict priority and weighted queues.

In an exemplary embodiment, AF1 through AF4 are set through an MPLS IP interface (not shown in FIGS. 5 and 6), as the service classes are defined. In another exemplary embodiment, a system wide default can be used to ease the configuration.

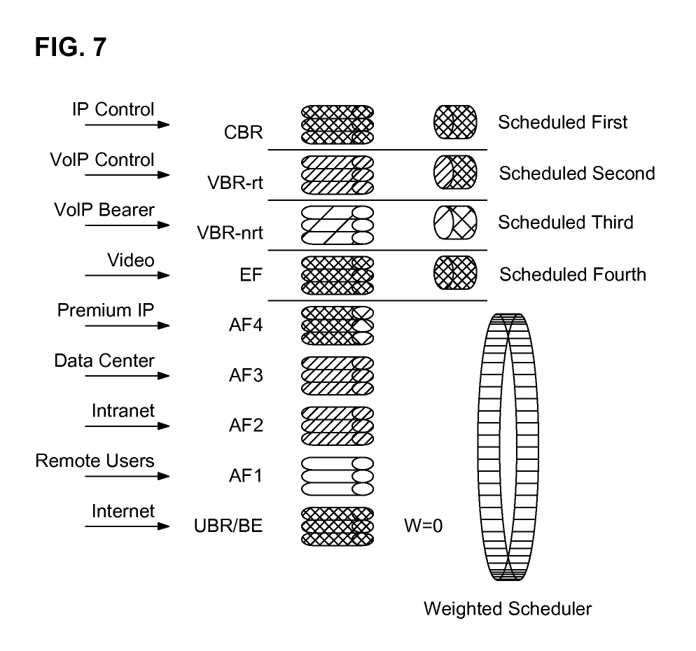

According to exemplary embodiments of the invention, any service in the system can use any combination of these service classes. In this context, “service” is used as meaning the type of traffic. For example, services requiring hard QoS, such as PWE3, Pseudo Wire Interface (PWI) and point-to-point circuits can use strict priority queuing. Services requiring soft QoS such as virtual private LAN service (VPLS) and Internet Protocol (IP) can use weighted priority queuing. Furthermore, services can be provisioned to use a mixture of strict and weighted priority queuing. As an example, IP services can be provisioned such that premium IP traffic such as voice over IP (“VoIP”) is offered strict priority and Internet traffic is offered weighted scheduling. FIG. 7 illustrates an exemplary offering of different types of traffic associated with different services classes which are prioritized using both strict and weighted scheduling in accordance with an embodiment of the present invention.

Exemplary embodiments of the invention employ E-LSPs (EXP-Inferred-LSP) as follows. Each E-LSP can have multiple classes of services corresponding to queues. Different E-LSPs can also be configured to have different combinations of scheduling queues, i.e., each E-LSP may not have the same service classes. As an example, one E-LSP can have all weighted service classes, another E-LSP can have all strict priority classes, a third E-LSP can have a mixture of these classes such as three (3) strict service classes and five (5) weighted service classes, a fourth E-LSP can have a different mixture of service classes such as four (4) strict priority service classes and four (4) weighted service classes. A service provider can limit the total number of combinations for operational ease.

The experimental bit inferred label switched path (E-LSP) includes a 3-bit Experimental Field (EXP) in the MPLS header. Thus, the MPLS EXP field restricts the number of priorities to eight (8), although in other exemplary embodiments of the invention can have more (or less) than 8 classes per E-LSP on the LSP originating node. Consequently, traffic will get different treatment within the node with each service class having its own treatment. At the egress point, just before the traffic exits the system, traffic from multiple classes may get marked with the same EXP bits, to accommodate the MPLS EXP framework limitation of 8 values.

In an alternative embodiment of the invention, another MPLS label header field is used to mark a packet's type of service class. Accordingly, it should be understood that using the EXP field is an exemplary method of providing a scheduler with information used to schedule traffic (i.e., packets).

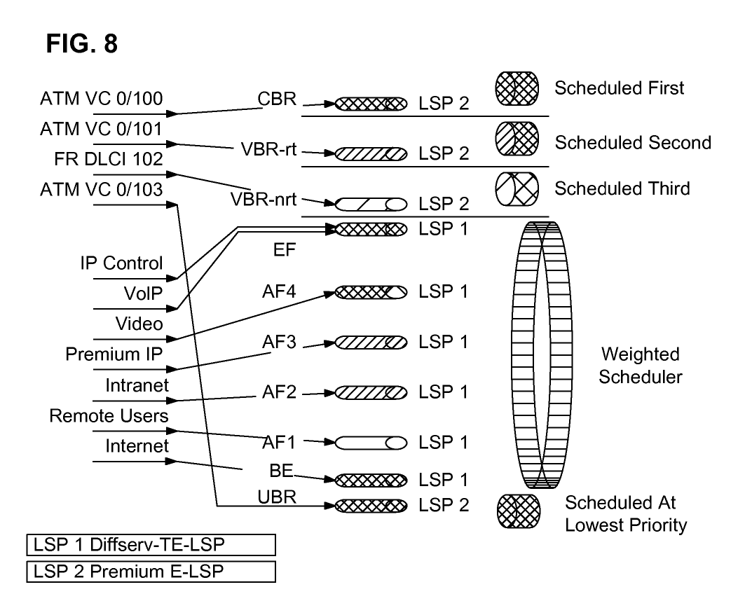

FIG. 8 represents two different LSPs in association with an MPLS network environment such as MPLS network environment 200, according to example embodiments of the invention. One E-LSP, LSP 1, has all weighted classes and is referred to as Differentiated Service Traffic Engineering (DiffServ-TE) E-LSP. This LSP is suited to carry multipoint traffic such as IP or virtual private LAN services (“VPLS”). A second E-LSP, LSP 2, has all strict priority classes and is referred to as a Premium E-LSP. This LSP is suited to carry point-to-point traffic such as asynchronous transfer mode (“ATM”) and frame relay (“FR”) type traffic.

Each LSP can support multiple services. In the above example, each E-LSP is limited to a single type of service such as PWE3 or VPLS/IP. Services are not mixed within a LSP since point-to-point and multipoint services have different characteristics. Point-to-point services typically require strict priority queuing whereas multipoint services typically require weighted scheduling. As shown, CBR, VBR-rt, and VBR-nrt strict priority service classes are scheduled first, second and third, respectively. Next the weighted priority classes EF, AF4, AF3, AF2 and AF1 are scheduled. Finally, the lowest priority service class, UBR/BE, is scheduled.

FIG. 9 depicts an exemplary EXP bit mapping of a premium E-LSP as described above with respect to FIG. 8, having CBR, VBR-rt, VBR-nrt, and UBR Service classes. FIG. 10 depicts an exemplary EXP bit mapping of an E-LSP which has all weighted classes (i.e., Diffserv-TE E-LSP). Particularly, the Diffserv-TE E-LSP is configured for EF, AF4, AF3, AF2, AF1 and BE service classes. It should be understood that the EXP bits mappings depicted in FIGS. 9 and 10 are exemplary and are fully configurable for other class arrangements within an E-LSP by an operator.

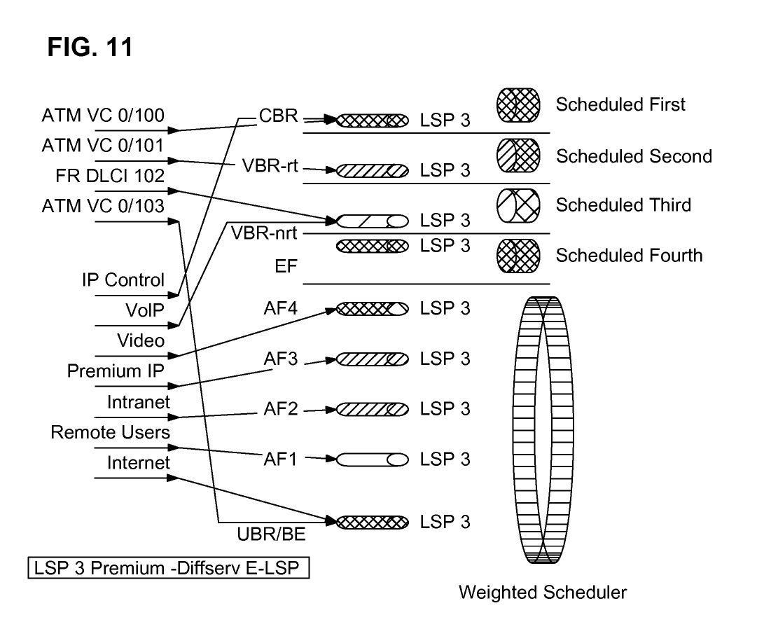

FIG. 11 illustrates another exemplary embodiment of the present invention, in which a single E-LSP (LSP 3) is configured to communicate a mixture of strict and weighted service classes. This E-LSP is suitable for carrying both point-to-point and multipoint traffic. All services can be mapped to all of the service classes or to a subset of the service classes which can be defined by the operator. Such configuration can be performed by an operator through a network management terminal coupled to the network (not shown) by modifying the EXP bits, exemplary settings of which will now be described in detail.

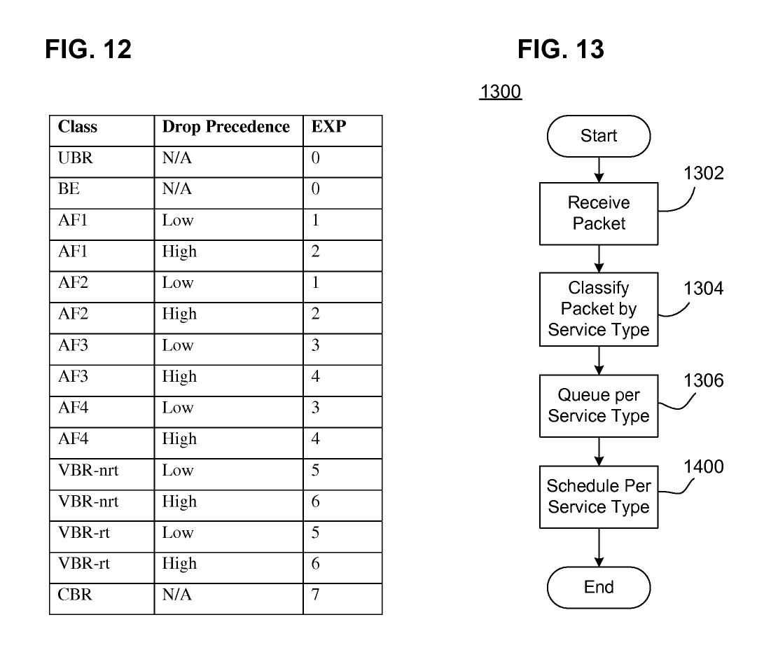

The Premium-Diffserv-TE E-LSP type in the above example can be configured as shown in FIG. 12. This type of LSP is referred to as a Premium-Diffserv-TE E-LSP. Each such E-LSP can have dedicated hardware resources (e.g., routers, switches, etc.), each of which can have distinct combinations of strict and weighted queues. This is applicable even if the different types of E-LSPs are on the same interface.

As shown in FIG. 12, the Premium-Diffserv-TE E-LSP is configured to transfer CBR, VBR-rt, VBR-nrt, AF4, AF3, AF2, AF1, BE and UBR type service classes. Each packet has a preconfigured drop precedence setting and service class as defined by presetting its EXP field. Thus, referring to FIGS. 11 and 12, CBR, VBR-rt, VBR-nrt and EF are strict priority classes scheduled first, second, third and fourth, respectively, and service classes AF4, AF3, AF2, AF1 and UBR/BE are scheduled next using a weighted scheduler.

In contrast to existing systems which support only either strict priority or weighted priority LSPs, the exemplary embodiments of the present invention described above can support both strict and weighted priority LSPs and can have the same LSP supporting both strict and weighted priority LSPs.

The templates (also referred to as “mappings” or “EXP bit mapping table”) shown in FIGS. 9, 10 and 12 are exemplary service templates which, when instantiated, yield a definite service requirement or policy. Other fields can be added to yield different service requirements/policies. For example, a template for an IPSec tunnel would contain additional fields defining tunnel end points, authentication modes, encryption and authentication algorithms, preshared keys if any, and traffic filters. In addition, an MPLS service template can contain fields such as the sites that need to form a VPN. An input service template for input IP interfaces or VPLS interfaces (e.g., multipoint services) in accordance with an exemplary embodiment of the present invention contains the following information: Filter type, Class type (one out of 8), Policer (off, low, medium, high drop precedence), as an appropriate allowed combination, Input Rate limiter on/off <rate>, Input Group on/off <Group-name>. In a preferred embodiment of the invention, this service template is stored on the ingress node and/or egress node on the network e.g., memory 304 (FIG. 3). In logical diagram 400 this template is depicted as EXP Bit Mapping Table 403.

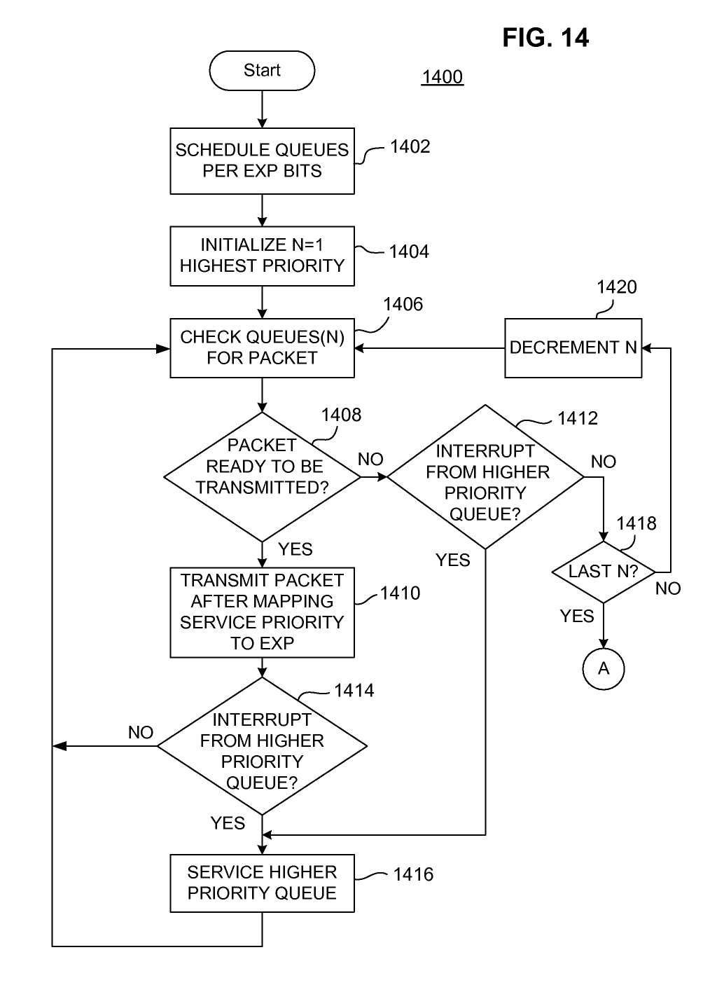

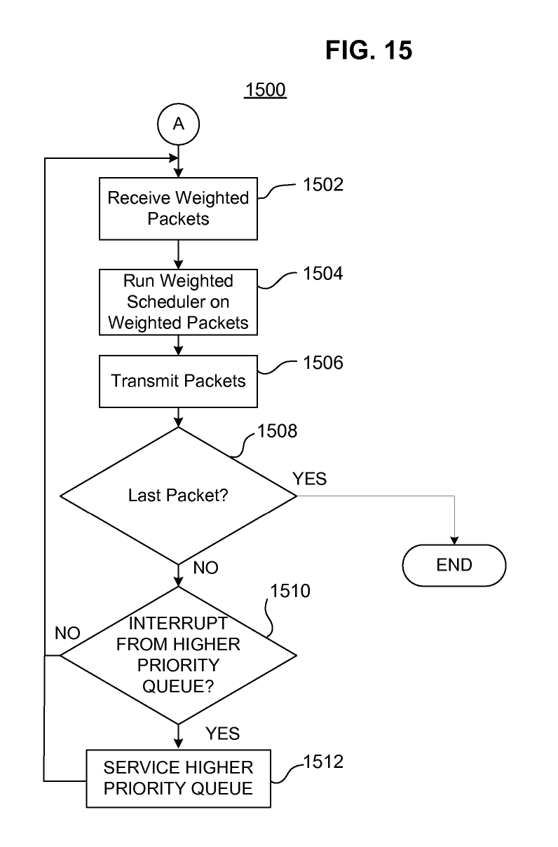

FIG. 13 is a flowchart illustrating a process 1300 performed by data processing system 300 (FIG. 3) on a node in network 200 (FIG. 2), such as a network router, switch or other node device (e.g., LSR, LER, FIG. 2). In particular, such node devices are configured to perform process 1300 (and the process of FIGS. 14 and 15 described below) and have modules as discussed above with respect to the logical diagram of FIG. 4 and may also be incorporated on an ASIC, PGA, FPGA, and the like.

Process 1300 is performed on packets received at a node in network 200, according to one embodiment of the present invention. In block 1302, a packet is received by the network node (e.g., LER 202, FIG. 2) from another upstream network node (not shown). Operating according to the prestored instructions 310b (FIG. 3), the network node then classifies (block 1304) the packet by service type which is pre-specified in the header of the packet. Once classified, the packet is queued per its classified service type, as shown in block 1306. Each network node, configures priority by either modifying a label prepended to the packet or by modifying an existing packet label by setting EXP bits therein in accordance with preestablished tables such as those depicted in FIGS. 9, 10 and 12. As described above, the exemplary tables shown in FIGS. 9 and 10 are used to configure two LSPs (LSP 1 and LSP 2 in FIG. 8) with differentiated service classes, whereas the exemplary table in FIG. 12 is used to configure a single LSP (LSP 3 in FIG. 12) capable of communicating differentiated service classes within a network 200 (FIG. 200). Once priority has been established in the network node, the packet is scheduled per its service type (block 1400). As explained above, a packet's priority designation can be established using other fields in the packet header. In other words, in the embodiment of the invention described herein, packet priority can be indicated by presetting its drop precedence fields (when applicable) and EXP field bits in the MPLS header. Alternatively, other packet header fields (or label fields) can be set and accomplish the same objective of scheduling a packet, and still be within the scope of the invention.

FIG. 14 is a flowchart showing a process 1400 illustrating more detail of process 1300 (FIG. 3), which schedules differentiated service classes associated with strict priority scheduling according to one embodiment of the present invention. Initially, at block 1402, the incoming packet is scheduled based on its EXP field value (e.g., EXP values as shown in FIGS. 9, 10 and 12). In particular, the EXP field value is compared to a table stored in the EXP bit mapping register 403 (FIG. 4). If a match is found, then the traffic data is stored in a queue corresponding to its service class.

Generally, strict priority service classes are serviced first and weighted priority classes are scheduled thereafter. Process 1400 of FIG. 14, which will be described in further detail below, processes the strict priority service class queues. Once completed, process 1400 passes control over to process 1500 (FIG. 15) which handles the weighted priority classes in a manner to be described below. While a lower priority service is being processed, if a higher priority service class has a packet that is ready to be transmitted, an interrupt is generated by processor 302 (FIG. 3) causing the processor 302 to service that packet as soon as possible. Preferably, the interrupt is serviced after a packet currently being processed has been transmitted from the queue.

Referring again to FIG. 14, at block 1404 a counter variable N is initialized to begin processing the highest priority service class. By example only, and referring also to the example shown in FIGS. 11 and 12, the highest priority service class in the example is the CBR service class. Accordingly, Queues(N), where N corresponds to the queues storing traffic of service class type CBR (EXP=7) is scheduled first, in that example, although of course the scope of the invention is not limited to that example only. Next at block 1406, the queues are checked to determine if a packet is ready to be transmitted. If a determination is made at block 1408 that a packet is ready to be transmitted, then at block 1410 it is transmitted to the next hop (i.e., from one node to the next) after mapping its service priority in accordance with an EXP field value stored in the EXP Bit register 407 in the egress buffer and traffic manager module 406 (FIG. 4).

For example, referring to FIG. 12, if a CBR and VBR-rt class packets have been received by the node from another node, they are queued in, for example, memory 304 (FIG. 3) which corresponds to the storage portion of ingress buffer and traffic manager 402 (FIG. 4). The VBR-rt class packet queue has been defined as having a priority of 6 (on a scale of 0-7, where 0 is the lowest priority and 7 is the highest), which is lower in priority than the CBR class packet queue which has a priority of 7. Accordingly, since the CBR queue has a packet that is ready to be sent, it will be transmitted first to the next node in the LSP. The packet's transmission is prioritized by mapping the EXP field of the packet to its corresponding service priority which is set by the policy of the node from which it shall egress.

If a packet is not ready to be transmitted (“No” at block 1408), then at block 1412 a determination is made whether a higher priority service class has caused an interrupt to request service. If a determination is made at block 1412 that there has not been an interrupt due to a higher priority packet being scheduled, then a determination is made as to whether the queues just serviced are the last queues to be serviced within a particular priority class. At block 1418, the queue counter N is checked to determine if the last strict priority queue N has been serviced for packets. If a determination is made at block 1418 that other priority queues still need to be serviced (i.e., the N counter has not yet reached the last N), then the queue counter, N, is decremented by ‘1’ to index queues corresponding to a lower service class, (block 1420). Thereafter, the process described above continues from block 1406.

If a determination is made at block 1412 than there has been an interrupt due to a higher priority packet being scheduled (“Yes” at block 1412), then that higher priority queue is serviced at block 1416 by a predetermined interrupt service routine. That routine sets N to the index of the queue being serviced and passes control back to block 1406 where the method then proceeds in the above-described manner to process the higher priority queue.

If a packet has been transmitted as described above with respect to block 1410, then a determination is made at block 1414 whether an interrupt has been triggered by a higher priority queue, such as by checking an interrupt service register bit in processor 310a, or by another conventional interrupt service routine. If a determination is made at block 1414 that an interrupt has been triggered, indicating that a packet has been classified and stored in a higher priority queue, then that higher priority queue is serviced at block 1416 by a predetermined interrupt service routine. That routine sets N to the index of the queue being serviced and passes control back to block 1406 where the method then proceeds in the above-described manner to process the higher priority queue. Otherwise, after a packet has been transmitted at block 1410, and if “No” at block 1414, the queue(s) corresponding to that packet's service class are checked again at block 1406 for packets that are ready to be transmitted and the process continues until all of the strict priority queue(s) have been serviced (“Yes” at block 1418).

It should be understood that other fields besides the EXP field can be used to identify service class priority and still be within the scope of the present invention.

As described above, process 1400 processes CBR, VBR-rt, VBR-nrt, and EF class packets, which are strict priority packets with higher priority than weighted class packets. After the strict priority service classes have been processed, the weighted service classes are processed by process 1500. Accordingly, process 1400 continues through connector (A) to process 1500 in FIG. 15 if the last N has been reached (i.e., “YES” at block 1418). Thus, process 1400 represents an exemplary first queue scheduling algorithm, while process 1500 represents an exemplary second queue scheduling algorithm. Advantageously, the present invention provides scheduling a first subset of the queues using the first queue scheduling algorithm and a second subset of the queues using the second queue scheduling algorithm. Additional subsets of queues can be defined and associated with other queue scheduling algorithms.

FIG. 15 illustrates process 1500 which processes service classes associated with weighted scheduling according to one embodiment of the present invention. In block 1502 a packet corresponding to a weighted service class is received. At block 1504 a weighted scheduler (e.g., as represented in FIGS. 6-8 and 11 as “Weighted Scheduler”) schedules weighted service class packets based on their weights using a weighted queue algorithm such as the WFQ algorithm discussed above. For example, referring to FIG. 12, an AF1, low-precedence, service class packet is weighted lower than an AF4, high-precedence, service class packet, and thus scheduled to be transmitted after the AF4, high-precedence, service class packet. Once scheduled, the packets are transmitted in accordance with their weights, as shown in block 1506. In the example above, the AF4 (high-precedence) service class packet is transmitted ahead of the AF1, low-precedence, service class packet.

If a determination is made at block 1508 that the packet was the last packet scheduled in the weighted queues, then process 1500 ends. Otherwise, if “No” at block 1508, a determination is made at 1510 whether a higher priority queue interrupt has been triggered. If so, then the packet stored in the higher priority queue is serviced at block 1512, after which control passes back to block 1502. Otherwise, if “No” at block 1510, control also passes back to block 1502 where process 1500 continues in the above described manner.

The foregoing invention provides improved methods and apparatus for managing differentiated service classes, that can carry multiple services with different requirements over a single path in the network. The invention also provides a mechanism to create an LSP which can combine both real-time and non-real-time services with differentiated levels among those services.

In the foregoing description, the invention is described with reference to specific example embodiments thereof. The specification and drawings are accordingly to be regarded in an illustrative rather than in a restrictive sense. It will, however, be evident that various modifications and changes may be made thereto, in a computer program product or software, hardware or any combination thereof, without departing from the broader spirit and scope of the present invention.

Software embodiments of the present invention may be provided as a computer program product, or software, that may include an article of manufacture on a machine accessible or machine readable medium having instructions (see e.g., FIG. 3). The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

What is claimed is:

1. A method for managing a plurality of differentiated service classes on a label switch path, comprising:
comparing at least one packet field value included in a packet of data to one or more mapping field values of a mapping that correlates the one or more mapping field values with a plurality of queues;
storing the packet into one of the plurality of queues based on the comparing;
scheduling a first subset of the plurality of queues using a first queue scheduling algorithm;
scheduling a second subset of the plurality of queues using a second queue scheduling algorithm; and
transmitting the packet onto the label switch path in accordance with a predefined scheduling order of the first subset of the plurality of queues and the second subset of the plurality of queues.

2. The method according to claim 1, further comprising:
defining the mapping; and
receiving the packet of data from a network.

3. The method according to claim 1, wherein the first scheduling algorithm is a strict priority queue scheduling algorithm and the second scheduling algorithm is a weighted queue scheduling algorithm.

4. The method according to claim 1,
wherein a first subset of the one or more mapping field values corresponds to a plurality of service classes, a second subset of the one or more mapping field values corresponds to a plurality of drop precedence, and a third subset of the one or more mapping field values corresponds to a plurality of predefined values, and
wherein the at least one packet field value contained in the packet of data corresponds to at least one of the first subset, the second subset and the third subset.

5. The method according to claim 1, further comprising:
prepending a label to the packet, wherein the label includes the at least one packet field value.

6. The method according to claim 1, further comprising:
modifying the at least one packet field value.

7. The method according to claim 1, further comprising:
receiving an interrupt indicating that another packet has been stored in a higher priority queue of the plurality of queues; and
servicing the higher priority queue immediately after the packet has been transmitted.

8. An apparatus for managing a plurality of differentiated service classes on a label switch path, comprising:
a memory operable to store a mapping that correlates one or more mapping field values with a plurality of queues;
a processor operable to compare at least one packet field value included in a packet of data to the one or more mapping field values of the mapping, store the packet into one of the plurality of queues based on the comparison, schedule a first subset of the plurality of queues using a first queue scheduling algorithm, schedule a second subset of the plurality of queues using a second queue scheduling algorithm; and
a transmitter operable to transmit the packet of data onto the label switch path in accordance with a predefined scheduling order of the first subset of the plurality of queues and the second subset of the plurality of queues.

9. The apparatus according to claim 8, further comprising:
a receiver operable to receive the packet of data from a network.

10. The apparatus according to claim 8, wherein the first scheduling algorithm is a strict priority queue scheduling algorithm and the second scheduling algorithm is a weighted queue scheduling algorithm.

11. The apparatus according to claim 8,
wherein a first subset of the one or more mapping field values corresponds to a plurality of service classes, a second subset of the one or more mapping field values corresponds to a plurality of drop precedence, and a third subset of the one or more mapping field values corresponds to a plurality of predefined values, and
wherein the at least one packet value contained in the packet of data corresponds to at least one of the first subset, the second subset and the third subset.

12. The apparatus according to claim 8, wherein the processor is further operable to prepend a label to the packet, wherein the label includes the at least one packet field.

13. The apparatus according to claim 8, wherein the processor is further operable to modify the packet field value.

14. The apparatus according to claim 8, wherein the processor is further operable to service an interrupt indicating that another packet has been stored in a higher priority queue of the plurality of queues.

15. A computer program product comprising a computer usable medium having control logic stored therein for identifying an error in a passive optical network, the control logic comprising:
computer readable program code to compare at least one packet field value included in a packet of data to one or more mapping field values of a mapping that correlates the one or more mapping field values with a plurality of queues;
computer readable program code to store the packet of data into one of the plurality of queues based on a comparison of the at least one packet field value and the mapping;
computer readable program code to schedule a first subset of the plurality of queues using a first queue scheduling algorithm;
computer readable program code to schedule a second subset of the plurality of queues using a second queue scheduling algorithm; and
computer readable program code to transmit the packet of data onto the label switch path in accordance with a predefined scheduling order of the first subset of the plurality of queues and the second subset of the plurality of queues.

16. The computer program product according to claim 15, further comprising:
computer readable program code to define the mapping; and
computer readable program code to receive the packet from a network.

17. The computer program product according to claim 15, wherein the first scheduling algorithm is a strict priority queue scheduling algorithm and the second scheduling algorithm is a weighted queue scheduling algorithm.

18. The computer program product according to claim 15,
wherein a first subset of the one or more mapping field values corresponds to a plurality of service classes, a second subset of the one or more mapping field values corresponds to a plurality of drop precedence, and a third subset of the one or more mapping field values corresponds to a plurality of predefined values, and
wherein the at least one packet field value contained in the packet corresponds to at least one of the first subset, the second subset and the third subset.

19. The computer program product according to claim 15, further comprising:
computer readable program code to prepend a label to the packet, wherein the label includes the at least one packet field value.

20. The computer program product according to claim 15, further comprising:
computer readable program code to modify the packet field value.

21. The computer program product according to claim 15, further comprising:
computer readable program code to service an interrupt indicating that another packet has been stored in a higher priority queue of the plurality of queues.

22. A system for managing a plurality of differentiated service classes on a label switch path on a network, comprising:
a first node device operable to prepend a label onto a packet of data, the label including at least one packet field value defining a priority of the packet, and to transmit the packet with the label onto the network; and
a second node device operable to receive the packet from the network, to compare the at least one packet field value with a predefined mapping defined to correlate one or more mapping field values with a plurality of queues, store the packet into one of the plurality of queues based on a comparison of the at least one packet field value and the mapping field values, to schedule a first subset of the plurality of queues using a first queue scheduling algorithm, to schedule a second subset of the plurality of queues using a second queue scheduling algorithm, and to transmit the packet to a next hop in accordance with a predefined scheduling order of the first subset of the plurality of queues and the second subset of the plurality of queues.
